(19) United States
(12) Patent Application Publication
(10) Pub. No.: US 2009/0267859 A1
(43) Pub. Date: Oct. 29, 2009

(54) End-fed planar type spiral antenna

(75) Inventors: Dong-Yean Koh, Uijeongbu-si (KR); Eun-Joo Kong, Anyang-si (KR); Sang-Won Kim, Seoul (KR)

Correspondence Address: STROOCK & STROOCK & LAVAN LLP, 180 MAIDEN LANE, NEW YORK, NY, 10038, US

(73) Assignee: LS Mtron, Ltd.

(21) Appl. No.: 12/381,001

(22) Filed: Mar. 5, 2009

(30) Foreign Application Priority Data
Apr. 29, 2008 (KR) 10-2008-0039834

(51) Int. Cl. H01Q 1/36; H01Q 1/50

(52) U.S. Cl. 343/860; 343/895

(57) ABSTRACT

An end-fed planar type spiral antenna for transmitting/receiving radio signals includes a spiral pattern formed to have inner and outer spiral curves turned predetermined times in a spiral shape from an arbitrary center point in a plane; a central circle pattern formed in a part of a central region of the spiral pattern in a circular shape; and a feed arm pattern formed in a rectangular shape from an end of the spiral pattern that turns predetermined times. Conductive material is patterned on a pattern where the spiral pattern, the central circle pattern and the feed arm pattern are overlapped. This antenna allows to design an antenna structure capable of effectively enhancing radiation efficiency and improving broadband characteristics by utilizing a tapered spiral structure. Also, this antenna has an improved orientation, ensures less limitation in height, and allows a small-size design.

### CROSS-REFERENCE TO RELATED APPLICATION

This application claims priority to Korean Patent Application no. 10-2008-0039834 filed on Apr. 29, 2008 the entirety of which is incorporated herein by reference.

### BACKGROUND OF THE INVENTION

1. Field of the Invention

The present invention relates to an end-fed planar type spiral antenna, and more particularly to an end-fed planar type spiral antenna capable of improving broadband characteristics and radiation efficiency while ensuring less limitation in height.

2. Description of the Related Art

Recently, as interests are focused on the fields of satellite communications, mobile communications and RFID (Radio Frequency Identification), antennas essential to radio signal transmission are actively studied. An antenna is a means for transmitting a specific frequency into the air or receiving a specific frequency from the air using its resonance characteristics. In particular, an antenna is greatly influenced from structure characteristics rather than electronic circuit characteristics. Antennas are classified into dipole antennas, loop antennas, spiral antennas and so on.

Among them, a spiral antenna is a frequency-independent antenna with a small structure, proposed in 1953 by E. M. Turner, and it has broadband matching characteristics and advantageously obtains circularly polarized waves. A conventional spiral antenna has a symmetric structure based on the spiral center, so it has a main beam of the circularly polarized wave in a direction perpendicular to the spiral plane on all frequency regions. In case of an eccentric spiral antenna whose center is moved outwards rather than a general spiral antenna structure, a main beam exhibits a circularly polarized wave, but the main beam is not perpendicular to the antenna plane but inclined thereto. This feature may be effective when the antenna is attached to a surface of a vehicle or airplane, and it is possible that only one device radiates a circularly polarized wave with a slope to the perpendicular direction. Also, since a conventional spiral antenna should be fed at the center of spiral, it was fed vertically from the center of the antenna. However, in case of the vertical feed method, the volume of the antenna is increased due to the vertical feed structure in spite of the spiral planar structure of a radiation device. In addition, a separate balun should be designed for matching of the feed portion, which is a difficult work. Thus, there is urgently demanded to develop a scheme capable of improving broadband characteristics and radiation efficiency of a spiral antenna and allowing to design or change an antenna structure such that optimal antenna parameters are calculated to decrease the volume of the antenna.

### SUMMARY OF THE INVENTION

The present invention is designed to solve the problems of the prior art, and therefore it is an object of the present invention to provide an end-fed planar type spiral antenna, which may have an antenna design capable of improving orientation and broadband characteristics of the antenna, allowing a smaller design with less limitations in height, ensuring easy mounting of a passive element for impedance matching, and enhancing radiation efficiency.

In order to accomplish the above object, the present invention provides an end-fed planar type spiral antenna for transmitting/receiving radio signals, which includes a spiral pattern formed to have an inner spiral curve and an outer spiral curve turned predetermined times in a spiral shape from an arbitrary center point in a plane; a central circle pattern formed in a part of a central region of the spiral pattern in a circular shape; and a feed arm pattern formed in a rectangular shape from an end of the spiral pattern that turns predetermined times, wherein conductive material is applied to the spiral pattern, the central circle pattern and the feed arm pattern.

Preferably, in the spiral pattern, the inner and outer spiral curves are defined using coordinate values Xn, Yn (n is an index of the inner or outer spiral curve) calculated by the following equation:

Xₙ=Aₙ×exp(αᵢ·θ)×cos(θ)

Yₙ=−Aₙ×exp(αⱼ·θ)×sin(θ)

0≦θ≦N×2π

where, Aₙ: a coordinate value of a center point of the spiral curve, αᵢ, αⱼ: turning ratio constants of the spiral curve, and N: a turn number of the spiral curve.

Preferably, the shape of the spiral pattern having the inner and outer spiral curves is determined by setting the turning ratio constants αᵢ, αⱼ: in the equation.

Preferably, the spiral pattern has a tapered spiral shape by setting the turning ratio constants αᵢ, αⱼ for different n (namely, the inner and outer spiral curves) into different values. Also, the spiral pattern may also have an oval spiral shape by setting the turning ratio constants αᵢ, αⱼ for X and Y at the same n (namely, the inner or outer spiral curve) into different values.

Preferably, the central circle pattern has a circular or oval shape partially coinciding with the outer spiral curve in the central region of the spiral pattern.

In the present invention, a feed portion may be vertically or horizontally connected to an end portion of the feed arm pattern.

In the present invention, a passive element is connected to the spiral pattern and the central circle pattern, or connected to portions with different turn numbers in the spiral pattern. The passive element may be a RLC (Resistor-Inductor-Capacitor) element circuit or an impedance matching circuit.

### BRIEF DESCRIPTION OF THE DRAWINGS

Other objects and aspects of the present invention will become apparent from the following description of embodiments with reference to the accompanying drawing in which:

FIG. 1 is a schematic view for illustrating a structure of an end-fed planar type spiral antenna according to a preferred embodiment of the present invention;

FIGS. 2a to 2c are schematic views showing various shapes of the spiral pattern used in the end-fed planar type spiral antenna according to the present invention;

FIG. 3 is a view showing current density of the end-fed planar type spiral antenna according to the present invention; and

FIG. 4 is a plane view showing that the end-fed planar type spiral antenna according to the present invention is patterned on a substrate.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

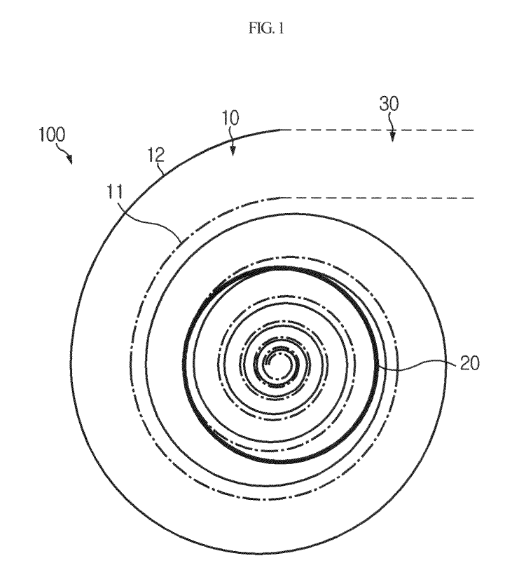

FIG. 1 is a schematic view for illustrating a structure of an end-fed planar type spiral antenna according to a preferred embodiment of the present invention.

Referring to FIG. 1, the end-fed planar type spiral antenna 100 of this embodiment includes a spiral pattern 10, a central circle pattern 20 and a feed arm pattern 30. Also, conductive material is applied to the spiral pattern 10, the central circle pattern 20 and the feed arm pattern 30.

The spiral pattern 10 is formed to have an inner spiral curve 11 and an outer spiral curve 12, which are turned predetermined times in a spiral shape from an arbitrary center point A in a plane. In the spiral pattern 10, the inner and outer spiral curves 11, 12 have an Archimedean spiral shape, and they are implemented using coordinate values Xₙ, Yₙ (n is an index of the inner or outer spiral curve) calculated by the following equation.

Xₙ=Aₙ×exp(αᵢ·θ)×cos(θ)

Yₙ=−Aₙ×exp(αⱼ·θ)×sin(θ)

0≦θ≦N×2π Equation 1

where, Aₙ: a coordinate value of a center point of the spiral curve, αᵢ, αⱼ turning ratio constants of the spiral curve, and N: a turn number of the spiral curve.

Seeing the equation 1, in the inner and outer spiral curves 11, 12 of the spiral pattern 10 according to the present invention, X and Y coordinates of the inner and outer spiral curves 11, 12 are defined according to an exponential function on which turning ratio constants αᵢ, αⱼ of the spiral curve starting from the center point A till the position of θ whose range is defined according to the turn number N of the spiral curve are reflected.

In the end-fed planar type spiral antenna 100 of the present invention, the structural features of the antenna are determined according to the turn number N of the spiral curve and the turning ratio constants αᵢ, αⱼ of the spiral curve. Here, the turning ratio constants αᵢ, αⱼ of the spiral curve are constants defining a relative difference of turning ratios between the inner spiral curve 11 and the outer spiral curve 12 and a relative difference of turning ratios between the X coordinate and the Y coordinate in the inner spiral curve 11 or the outer spiral curve 12.

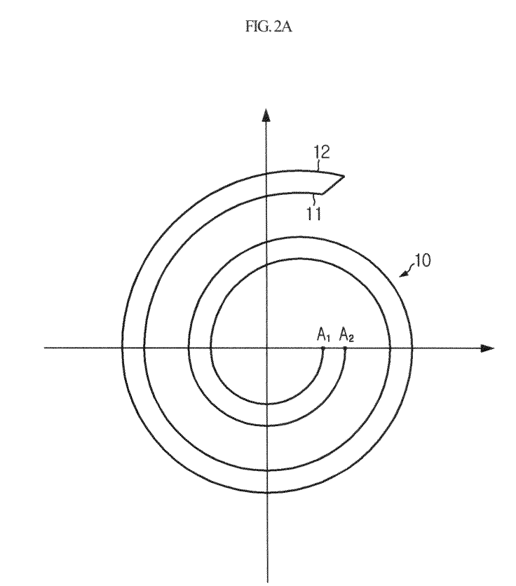

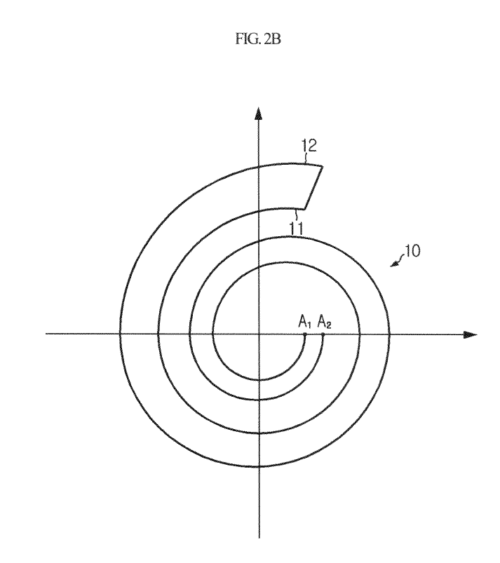

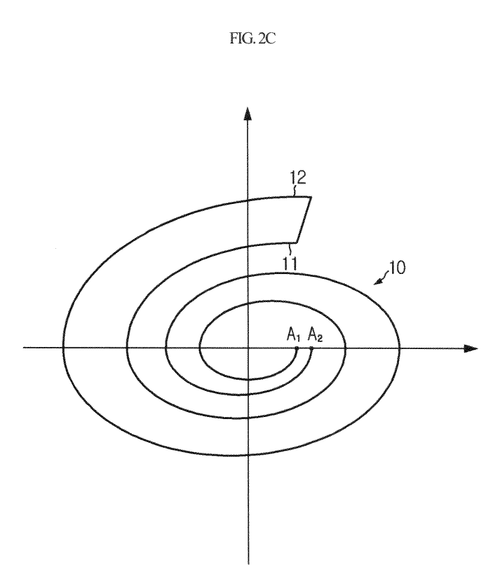

Hereinafter, various structural shapes of the spiral pattern according to the turning ratio constants αᵢ, αⱼ of the spiral curve are explained in detail with reference to FIGS. 2a to 2c.

FIGS. 2a to 2c are schematic views showing various shapes of the spiral pattern used in the end-fed planar type spiral antenna according to the present invention.

FIG. 2a shows the case that the turning ratio constants αᵢ, αj of the inner and outer spiral curves 11, 12 are identical. In this case, the inner spiral curve 11 and the outer spiral curve 12 are turned in the same spiral shape, so a gap between the inner and outer spiral curves 11, 12 is kept constantly. Thus, the spiral pattern 10 has a general spiral structure.

FIG. 2b shows the case that the turning ratio constants aᵢ, αⱼ of the inner and outer spiral curves 11, 12 are different from each other. In this case, the inner spiral curve 11 and the outer spiral curve 12 are turned in different spiral shapes, so the gap between the inner and outer spiral curves 11, 12 is broadened as they are turned. Thus, the spiral pattern 10 has a tapered spiral structure.

FIG. 2c shows the case that the turning ratio constants αᵢ, αⱼ of the X and Y coordinates in the inner and outer spiral curves 11, 12 are different from each other, and in this case, the inner spiral curve 11 and the outer spiral curve 12 are turned in an oval shape. At this time, if the turning ratio constants of the inner and outer spiral curves 11, 12 are identical to each other, the gap between the inner and outer spiral curves 11, 12 is constantly kept. However, if the turning ratio constants are different from each other, the gap between the inner and outer spiral curves 11, 12 is broadened as they are turned, so the spiral pattern 10 has a tapered spiral structure.

In the end-fed planar type spiral antenna 100 of the present invention as explained above, the turn number N and the turning ratio constants αᵢ, αⱼ of the inner and outer spiral curves 11, 12 of the spiral pattern 10 are calculated using an optimized method using the numerical analysis, so it is possible to design an antenna structure capable of ensuring best performance of the antenna under various conditions such as use environment of the antenna, used frequency and a substrate on which the antenna is patterned. For example, if the antenna is designed with the tapered spiral structure as shown in FIGS. 2b and 2c, the antenna may be used in a broad band.

The central circle pattern 20 is formed with a circular shape partially coinciding with the outer spiral curve 12 in a center portion of the spiral pattern 10. The central circle pattern 20 may have a circular or oval shape depending on the shape of the outer spiral curve 12.

The end-fed planar type spiral antenna 100 of the present invention may enhance radiation efficiency using the central circle pattern 20. The antenna has a main radiation portion at a position furthest from a feed line (not shown). In the present invention, the feed line is positioned at an end portion of the spiral pattern 10, not a center portion thereof, so the main radiation portion is positioned at the center portion of the spiral pattern 10. In particular, if a resistance component of the main radiation portion is lowered, high radiation efficiency is obtained. For this purpose, the central circle pattern 20 is formed to allocate a relatively wider area. The size of the central circle pattern 20 is partially coinciding with the outer spiral curve 12 of the spiral pattern 10, and it is possible to design an antenna with high radiation efficiency in an effective way by adjusting the central circle pattern 20 into a size calculated by an optimized method using the numerical analysis.

The feed arm pattern 30 is formed in a rectangular shape from the end of the spiral pattern 10. A feed portion (not shown) is connected to an end portion of the feed arm pattern 30. The feed portion may be connected to the feed arm pattern 30 vertically or horizontally.

The end-fed planar type spiral antenna 100 according to the present invention may improve orientation of the antenna by positioning the feed arm pattern 30 at the end portion of the spiral pattern 10.

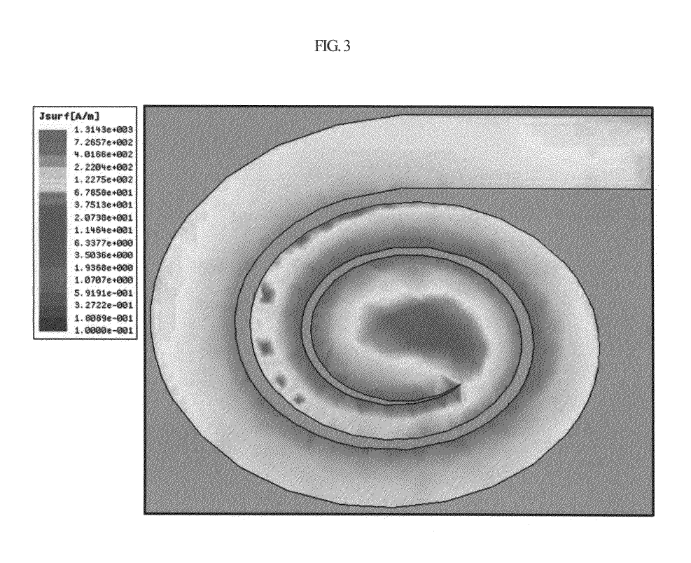

FIG. 3 shows current density of the end-fed planar type spiral antenna according to the present invention.

Referring to FIG. 3, it would be understood that electric current supplied from the feed portion connected to the feed arm pattern 30 exhibits current density rapidly decreased at the central circle pattern 20. It is because induced current is propagated in the central circle pattern 20. In the end-fed planar type spiral antenna 100 of the present invention, the central circle pattern 20 is formed to improve propagation of induced current, namely to enhance radiation efficiency, and the tapered spiral pattern 10 is formed to reinforce broadband characteristics. Also, the feed arm pattern 30 is formed at the end portion of the spiral pattern 10, and the feed portion is connected thereto to enhance orientation of the antenna.

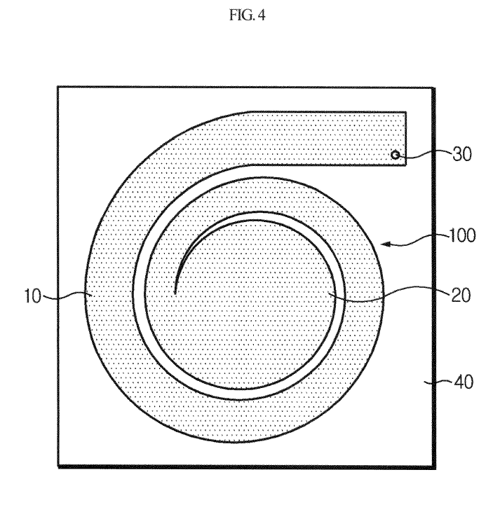

FIG. 4 is a plane view showing that the end-fed planar type spiral antenna according to the present invention is patterned on a substrate.

Referring to FIG. 4, in the end-fed planar type spiral antenna 100 of the present invention, conductive material is applied to the spiral pattern 10, the central circle pattern 20 and the feed arm pattern 30 formed on a planar substrate 40. In this embodiment, conductive ink is printed on the substrate 40. However, the present invention is not limited thereto. For example, pure metals such as copper, copper alloy and aluminum may be used as the conductive material, and the conductive material may be formed on the substrate by etching or deposition, instead of printing.

In the end-fed planar type spiral antenna 100 of the present invention, a passive element such as RLC useable for impedance matching to enhance transmission sensitivity may be connected at a position of the spiral pattern 10 and the central circle pattern 20. In addition, a passive element may also be connected between portions of the spiral pattern 10 with different turn numbers.

As mentioned above, the end-fed planar type spiral antenna 100 of the present invention allows to design an antenna structure capable of improving broadband characteristics and effectively enhancing radiation efficiency due to the structural characteristics such as the tapered spiral structure, the central circle structure and the connection of the feed lint to the end portion.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### APPLICABILITY TO THE INDUSTRY

According to the present invention, it is possible to design an antenna structure capable of effectively enhancing radiation efficiency and improving broadband characteristics by utilizing a tapered spiral structure. Also, the antenna of the present invention has an improved orientation due to the end-fed manner, ensures less limitation in height, and allows a small-size design since the antenna may receive a long wavelength in comparison to area. In addition, it is easy to mount a passive element required for impedance matching to the antenna.

What is claimed is:

1. An end-fed planar type spiral antenna for transmitting or receiving radio signals, comprising:
a spiral pattern formed to have an inner spiral curve and an outer spiral curve turned predetermined times in a spiral shape from an arbitrary center point in a plane;
a central circle pattern formed in a part of a central region of the spiral pattern in a circular shape; and
a feed arm pattern formed in a rectangular shape from an end of the spiral pattern that turns predetermined times,
wherein conductive material is applied to the spiral pattern, the central circle pattern and the feed arm pattern.

2. The end-fed planar type spiral antenna according to claim 1, wherein, in the spiral pattern, the inner and outer spiral curves are defined using coordinate values Xₙ and Yₙ where n is an index of the inner or outer spiral curve calculated by the following equation:
Xₙ=Aₙ×exp(αᵢ·θ)×cos(θ)
Yₙ=−Aₙ×exp(αⱼ·θ)×sin(θ)
0≦θ≦N×2π
where, Aₙ is a coordinate value of a center point of the spiral curve, αᵢ, and αⱼ are turning ratio constants of the spiral curve, and N is a turn number of the spiral curve.

3. The end-fed planar type spiral antenna according to claim 2,
wherein the shape of the spiral pattern having the inner and outer spiral curves is determined by setting the turning ratio constants αᵢ, and αⱼ in the equation.

4. The end-fed planar type spiral antenna according to claim 3,
wherein the spiral pattern has a tapered spiral shape by setting the turning ratio constants αᵢ and αⱼ for different n indexes into different values.

5. The end-fed planar type spiral antenna according to claim 3,
wherein the spiral pattern has an oval spiral shape by setting the turning ratio constants αᵢ and αⱼ for X and Y at the same n index into different values.

6. The end-fed planar type spiral antenna according to claim 1,
wherein the central circle pattern has a circular or oval shape partially coinciding with the outer spiral curve in the central region of the spiral pattern.

7. The end-fed planar type spiral antenna according to claim 1,
wherein a feed portion is vertically connected to an end portion of the feed arm pattern.

8. The end-fed planar type spiral antenna according to claim 1,
wherein a feed portion is horizontally connected to an end portion of the feed arm pattern.

9. The end-fed planar type spiral antenna according to claim 1,
wherein a passive element is connected to the spiral pattern and the central circle pattern.

10. The end-fed planar type spiral antenna according to claim 9,
wherein the passive element is a Resistor-Inductor-Capacitor element circuit or an impedance matching circuit.

11. The end-fed planar type spiral antenna according to claim 1,
wherein a passive element is connected to portions with different turn numbers in the spiral pattern.

12. The end-fed planar type spiral antenna according to claim 11,
wherein the passive element is a Resistor-Inductor-Capacitor element circuit or an impedance matching circuit.
